(19) United States
(12) Patent Application Publication
(10) Pub. No.: US 2008/0156844 A1
(43) Pub. Date: Jul. 3, 2008

(54) STAPLE GUN

(76) Inventors: Austin Raymond Savio Braganza, Milwaukee, WI (US); Patrick J. Radle, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 11/619,241

(22) Filed: Jan. 3, 2007

(51) Int. Cl. B25C 5/00

(52) U.S. Cl. 227/109; 227/120

(57) ABSTRACT

A staple gun has weight added so as to increase its inertia and has a cable guide member with cable guides at both ends that can be reversed for driving different sized staples. The stapler has a fulcrum member shaped to take advantage of greater hand strength when one's fingers are clenched as compared to hand strength when one's fingers are more outstretched. The feed head of the stapler is configured to prevent staples from jamming.

### CROSS-REFERENCE TO RELATED APPLICATION

Not applicable.

### STATEMENT CONCERNING FEDERALLY SPONSORED RESEARCH

Not applicable.

### FIELD OF THE INVENTION

This invention relates to staple guns of the type that are used for driving staples, typically into a wooden substrate, and which are normally used to secure wires installed in homes and buildings.

### BACKGROUND OF THE INVENTION

Heavy-duty staple guns or staplers, which may be either manually or electrically operated, are normally used to secure wires that are run throughout a building. The staples oftentimes have a U-shaped plastic body in which a metal U-shaped staple fastener is held ready to be driven and the metal legs of the staple extend down through holes in the legs of the plastic body. The cable or wire (“cable” and “wire” are used synonymously herein) is typically held inside the “U” shaped opening of the plastic body. The staple secures the plastic body to the wooden or other material substrate to which the cable is secured, and the plastic body protects the wire/cable insulation from being damaged by the metal staple.

Not all wires secured by these staplers are the same size or shape, so it is desirable for each stapler to be able to secure a variety of different sizes and/or shapes of wires. It is known in such staplers to provide a cable guide at the front bottom of the stapler through which the wire extends when the wire is being stapled. The cable guide serves to center the wire under the staple prior to driving the staple. The cable guide has a guideway opening in it which closely approximates the size and shape of the cable opening in the plastic body of the staple being applied. This assures that the staple being applied is the correct staple for the wires being secured. For staplers that can accommodate different sizes and/or shapes of wires, typically more than one guide is used and the guides can be removed from the stapler and replaced with a guide having an opening of a different size and shape, to match different staples the staple gun is capable of driving. For convenience and to reduce the tendency for losing cable guides, provisions must be made for storing the guides on the stapler.

In addition, staple guns of this type must be made very rugged and durable, as they are subjected to rough use. Further, the staples are driven with considerable force, and the driving force has an equal and opposite reactive force which must be absorbed by the stapler and the user. Preferably, the stapler makes it as easy and as non-fatiguing as possible for the user to perform the stapling tasks.

### SUMMARY OF THE INVENTION

The invention provides a staple gun of the type that has a body that includes a staple chamber that holds staples in line to be fed below a hammer contained in the body. An actuator linkage lifts the spring-loaded hammer to drive the staple presented in the chamber below the hammer. In one aspect of the invention, the body contains one or more separate auxiliary weights that serve to increase the weight and inertia of the stapler. The weights help to absorb the reactive force of the hammer driving the staple, thereby reducing fatigue on the user who has to provide a reaction force. In addition, the weights help the stapler to be perceived as a heavy-duty tool, even though the stapler may have lightweight plastic components, as compared to a metal housing stapler.

In this aspect, in a preferred form, the additional weight is positioned in the body in the area of the body where the hammer force is reacted against.

Also in this aspect, the weights are preferably positioned at low elevation in the stapler body to lower the center of gravity of the stapler so that it is more likely to stand upright when placed on a surface.

In another aspect of the invention, the staple gun is capable of driving at least two differently configured staples. In this aspect, a double-ended cable guide member is used in the staple gun that has one end configured as a first guideway for one of the staples and an opposite end configured as a second guideway for the other of the staples. The staples and correspondingly shaped guideways of the cable guide member may be of different widths, and/or different heights. This way, multiple staples can be accommodated without having additional cable guide members that have a tendency to get lost or misplaced, or require other means to store them on the stapler.

In this aspect, in a preferred form, the staples in the chamber stop against a rear surface of the cable guide member. Preferably, the cable guide member can only be inserted into the staple gun with the rearward surface facing rearwardly. A cable guide stop may be provided, and the cable guide member may be offset laterally to fit with the cable guide stop to assure that it can be inserted into the staple gun in only the correct orientation, with its forward side facing forwardly, but with either end down.

In addition, preferably the cable guide member has indicia to indicate which surface is its rearward surface. In addition, the cable guide member can have indicia to indicate which guideway to use for different staples.

The cable guide member can also be provided with grippers to facilitate removal from the stapler by a user.

In designs where the different staples that can be driven by the stapler are at different heights, in one orientation the cable guide member supports the stapler further from the substrate than in the other orientation.

In another aspect of the invention, a fulcrum member is shaped so as to contact the leaf springs at varying locations during the stapling stroke to provide varying effective lever arm lengths and mechanical advantage of loading the leaf springs and optimize the handle actuation force to match the variation in hand strength of a person according to the amount one's fingers are outstretched during the handle compression stroke. The varying fulcrum locations can be any location on a continuous path, or can be discrete locations determined by multiple and distinct contact points between the leaf spring and the fulcrums.

In another aspect of the invention, the stapler feed head is configured so as to provide pushing surfaces for the staples and to prevent a staple in the channel from leaning too far backwards in order to keep the stapler from jamming during hammer actuation while driving a staple.

These and other objects and advantages of the invention will be apparent from the detailed description and drawings.

### BRIEF DESCRIPTION OF THE DRAWINGS

FIG. 1 is a perspective view of a staple gun of the invention, showing the same cable guide member in two orientations exploded therefrom, one in one orientation, with one end up, and the other in the opposite orientation, with the other end up;

FIG. 2 is another exploded perspective view of the staple gun with more of the parts exploded away and half of the staple gun body removed;

FIG. 3 is a view illustrating how the cable guide stop prevents incorrect insertion of the cable guide member;

FIG. 4 is a perspective view illustrating how the cable guide stop interacts with the cable guide member when correctly inserted;

FIG. 5 is an enlarged view of a row of staples to be used with a stapler of the type contemplated;

FIG. 6 is a front plan view of the cable guide member;

FIG. 7 is a rear plan view of the cable guide member;

FIG. 8 is a perspective view of the cable guide member;

FIG. 9 is a front-end plan view of the staple gun shown stapling a round cable against a substrate surface with the associated end of the cable guide member guiding the wire and a flat cable drawn in phantom which could be secured instead of the round cable;

FIG. 10 is a view like FIG. 9, but with the larger opposite end cable guideway of the cable guide member guiding the larger wire;

FIG. 11 is a side plan view of the staple gun with half of the body removed and other components shown in section;

FIG. 12 is a detail view of the portion 12-12 indicated in FIG. 11;

FIG. 13 is a cross-sectional view from the plane of the line 13-13 of FIG. 12;

FIG. 14 is a view like FIG. 11 but with the actuator depressed so as to raise the hammer and be on the verge of releasing the hammer;

FIG. 15 is a detail view of portion 15-15 of FIG. 14;

FIG. 16 is a view like FIG. 15, but showing the hammer just released from the actuator lever;

FIGS. 17a and 17b are cross-sectional views of another embodiment of a staple gun illustrating a differently shaped fulcrum member and with some of the ribbing removed;

FIG. 18 is another perspective view of the staple gun of FIG. 1 with half of the staple gun body removed and illustrating the staple feed head;

FIG. 19 is a perspective view of the spring-biased feed head mounted in the metal liner;

FIG. 20 is a perspective view of the feed head;

FIG. 21 is a cross-sectional view of the pusher showing a staple in the channel and a single staple in the trackway;

FIG. 22 is a perspective view of the stapler passageway showing a stop that prevents the feed head from traveling forward into the path of the hammer;

FIGS. 23a-23c illustrate different sized staples in the trackway of the liner; and

FIGS. 24a-24c are cross-sectional views of another embodiment of a staple gun illustrating another fulcrum member.

### DETAILED DESCRIPTION OF THE PREFERRED EMBODIMENT

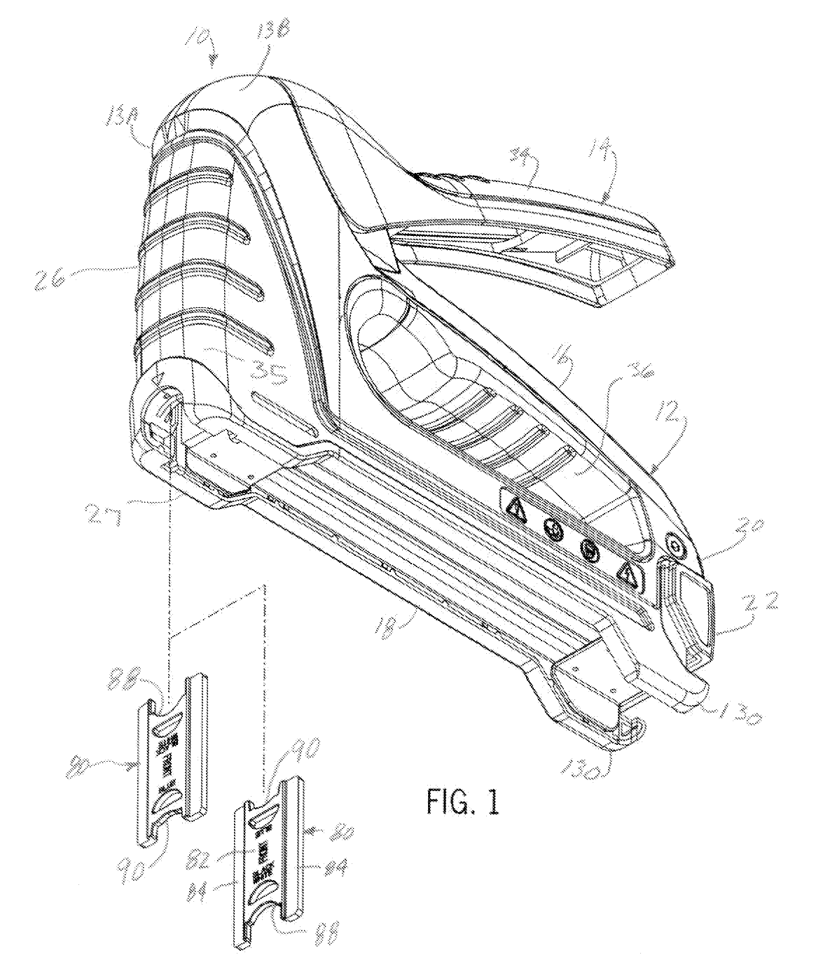

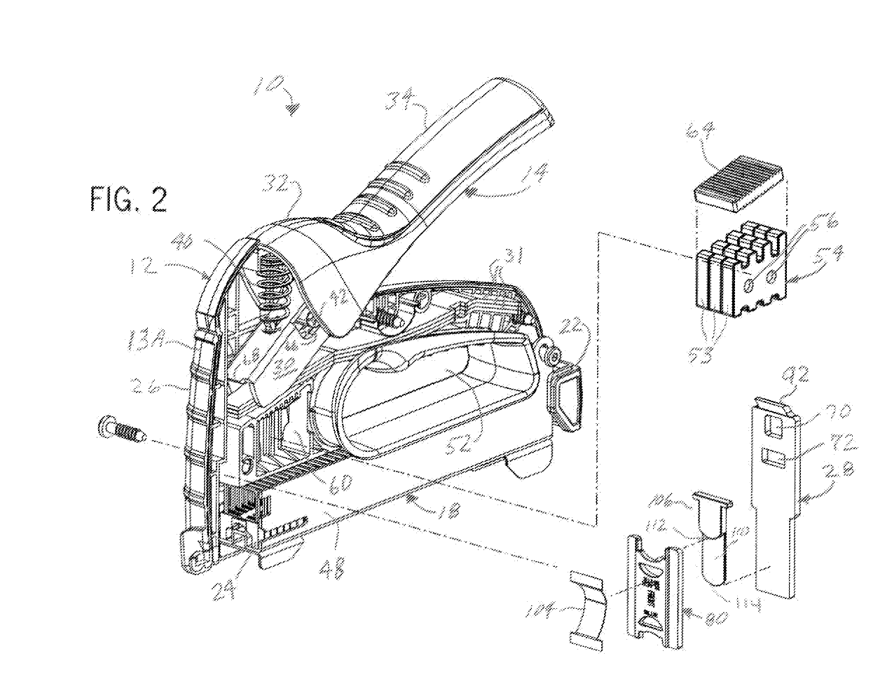

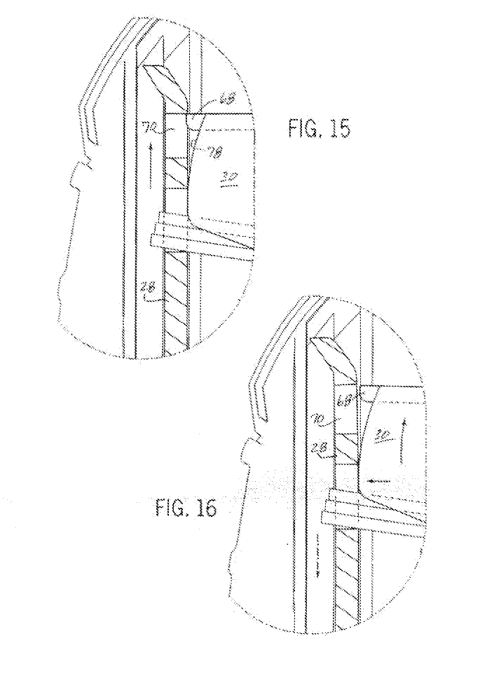

Referring to FIGS. 1 and 2, a stapler 10 of the invention has a body 12 to which an actuator lever 14 is pivotally attached for manual actuation. The body 12 has a handle portion 16, a staple chamber portion 18 spaced below the handle 16, a rear end 20 into which a pusher 22 is installed in ordinary fashion that uses a spring to push a row of staples 24 (FIGS. 2 and 5) forwardly, and a front or head 26 in which a hammer 28 resides that drives the staple positioned below it. The housing of the body 12 includes two housing halves 13A and 13B which may be plastic and are fastened together. The hammer 28 can slide up and down in the head 26 in tracks or guides defined by the housing halves 13A and 13B, the hammer 28 being lifted by the actuator lever 14 when it is pivoted by the user. When the actuator lever 14 disengages from the hammer 28 at the top of the hammer stroke (FIGS. 15 and 16), the hammer 28 is driven downwardly by leaf springs 31 to drive the staple into the substrate, which is typically a wooden stud or joist.

The stapler 10 is made of a combination of plastic and metal parts, with the actuator lever 14 having a metal spine 30 that is covered by a plastic covering sheath 32 in the handle portion of the lever 14. The sheath 32 also closes the joint between the lever 14 and the body 12 where the lever 14 enters the body 12 so as to give a more finished aesthetically pleasing appearance and to reduce the possibility of pinching the user. The covering sheath 32 preferably has a rubber overmolding 34 in the handle portion of the lever 14 where it contacts the user's hand. Rubber overmolding 36 is also provided on the underside of the handle 16 of the body 12 where hand contact with the user is also encountered. The rubber overmolding 34, 36 enhances user control of the stapler using either or both hands, and provides a soft touch as well as a sure grip. Rubber overmolding 35 is also provided on the front end of the stapler at head 26, extending along lower outer edges of chamber 18, front feet 37, and back feet 130. These rubber covered feet 37, 130 improve the grip of the stapler on a work surface to prevent sliding and also aid in the positioning of the stapler and thus the location of a staple in a substrate. Further, the rubber covered feet 37, 130 help protect the stapler 10 by absorbing some of the impact forces in the event that the stapler 10 is dropped.

The covering sheath 32 is fastened to the metal spine 30 by any suitable attachment, which may be a mechanical locking engagement, a frictional attachment or an adhesive attachment. The front end of the actuator lever 14 is biased downwardly by compression spring 40, which extends between the top portion of the spine 30 in front of pivot 42 and the top portion of body 12. The spring serves to return the actuator to its original position and reengage the lever 14 with the hammer after completing a staple driving cycle.

The chamber 18 of the body 12 is lined by a sheet metal liner 48 which defines a trackway for the row of staples. As described below, the staples are pushed forwardly to position a staple under the hammer by a feed head and a spring of pusher 22. The plastic body part 94 of the staples are held together in a row but easily separated from the row when the hammer 28 strikes the metal fastener part 95 of the staple to drive it down through the legs on the plastic body 94 and into the substrate.

In the lower part of the head 26, above the chamber 18 and in front of the handle 16, directly in front of the handle hole 52, a recess is formed in the body 12 for receiving an auxiliary weight 54 which as illustrated is made of free weights 53 that are snap fit together by the depressions 56 that form dimples on the opposite sides of the weights which fit into the depressions of the next adjacent weight 53. The three weights 53 are snapped together and then are received in the recess 60 of the body in an interference fit so that the weight does not rattle around. The weight 54 increases the weight of the stapler 10, thereby increasing its inertia, and the housing recess positions the increased weight near to where the hammer impacts the staple so as to help absorb the impact and provide a reactive force so that it does not need to be absorbed by the user. The increased weight of the stapler 10 also creates an impression of quality to the user by enhancing the user's perception of the heavy-duty properties of the stapler 10.

Directly above the weight 54, the body 12 has another cavity formed in it in which is received a pad 64 made of an elastomer or other relatively soft energy absorbing material that the frontal portion of the springs 31 strikes at the bottom of its downstroke. The pad 64 also helps dissipate destructive energy following the release of the hammer to reduce stress on the housing.

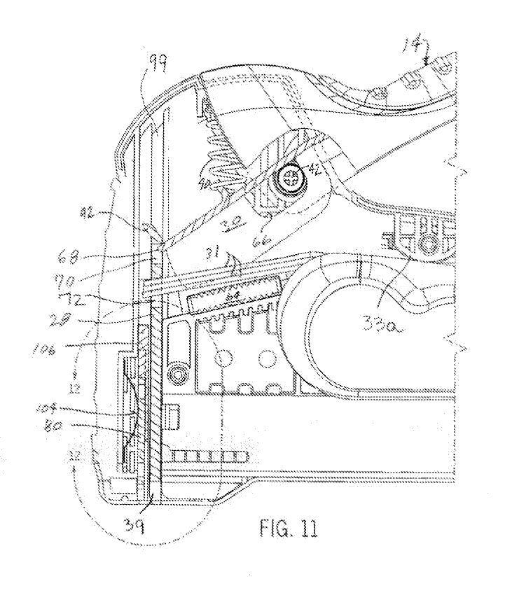

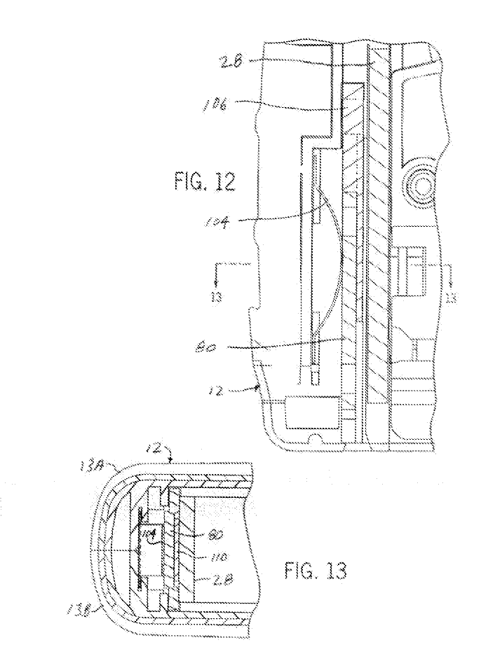

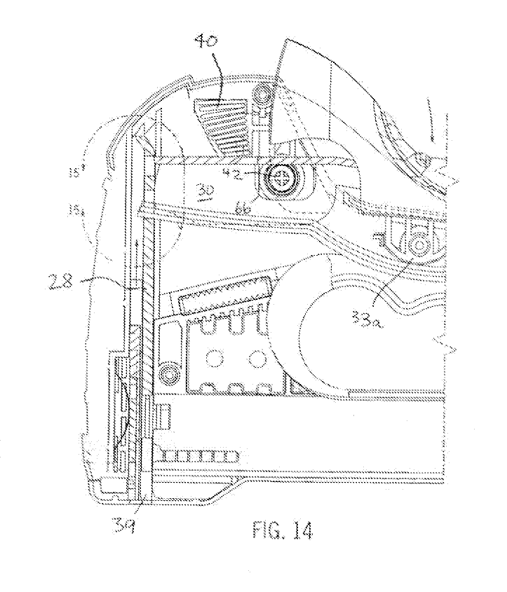

Referring to FIGS. 11, 14, 15 and 16, a staple is driven by depressing the handle portion of lever 14 toward the handle 16, which causes the lever 14 to pivot about pivot 42. Pivot 42 rides in slot 66 of the metal spine 30 of the actuator lever. The compression spring 40 tends to push the spine 30 forwardly in the at rest position (FIG. 11) of the lever 14 so as to engage nose 68 in the hole 70 at the top of the hammer 28. Springs 31 extend into the hole 72 of the hammer which is right below the hole 70. Rotating the rear end of the actuator lever 14 down about pivot 42 rotates the front end of the lever 14 up, which lifts the hammer 28 against the action of the springs 31, which tend to bias the hammer 28 downwardly with a significant force. Ends of the springs 31 are also lifted upwardly. A fulcrum member 33a which includes a plastic frame and a metal reinforcement surface contacts the leaf springs 31 at an area of contact to define a fulcrum for bending the springs. Referring to FIGS. 14, 15 and 16, as the hammer 28 reaches the upper limit of its stroke, the lever 14 is moved rearwardly, permitted by the pivot 42 riding in the slot 66 of lever 14, and facilitated as the angle of the lever changes by the front edge 78 of the spine 30 camming on the rear surface of the hammer 28, which pushes the hammer 28 out of engagement with the nose 68. When the nose 68 becomes fully disengaged from the hole 70 as shown in FIG. 16, the springs 31 drive the hammer 28 downwardly in a channel 39 to drive the U-shaped staple to secure a wire with the staple.

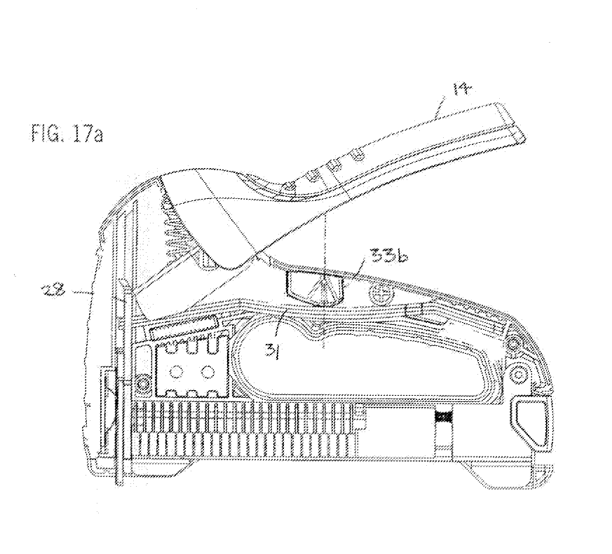

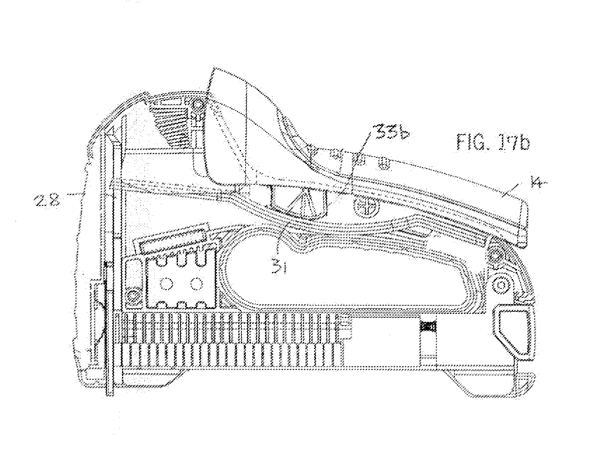

As shown in FIGS. 17a and 17b, in another embodiment the stapler 10 includes a differently shaped fulcrum member 33b which is configured to take advantage of the variation in hand strength of a person according to whether one's fingers are outstretched or more clenched. In particular, fulcrum member 33b contacts the leaf springs 31 at an area of contact or fulcrum such that the fulcrum moves closer to the loaded end of the spring during a stapling stroke. As the handle portion of lever 14 is moved from an at rest position, such as shown in FIG. 17a, such as shown in FIG. 17b, fulcrum member 33b contacts the springs 31 at varying contact areas. The fulcrum location defined by the contact area between the springs 31 and fulcrum member 33b moves closer to the loaded end of the spring along a path at a rate greater than if the fulcrum path was defined by fixed radius fulcrum member 33a, such as shown in FIGS. 11 and 14. This means that an effective lever arm length of the springs 31 is greater at the beginning of a stapling stroke compared to later in the stapling stroke. A longer effective lever arm at the beginning of a stapling stroke corresponds to a greater mechanical advantage, such that less hand force is required to deflect the ends of springs 31 a predetermined amount at the beginning of a stapling stroke as compared to later in the stapling stroke. This is advantageous in that it conforms to a person's natural hand strength when operating the stapler 10. In other words, when one's fingers are more outstretched, such as at the beginning of a stapling stroke, hand strength is smaller compared to when one's fingers are contracted inwardly toward the palm, such as at the end of a stapling stroke, and thus the provision of a greater mechanical advantage to correspond to more outstretched fingers and a lesser mechanical advantage to correspond to more clenched fingers is a desirable feature provided by fulcrum member 33b.

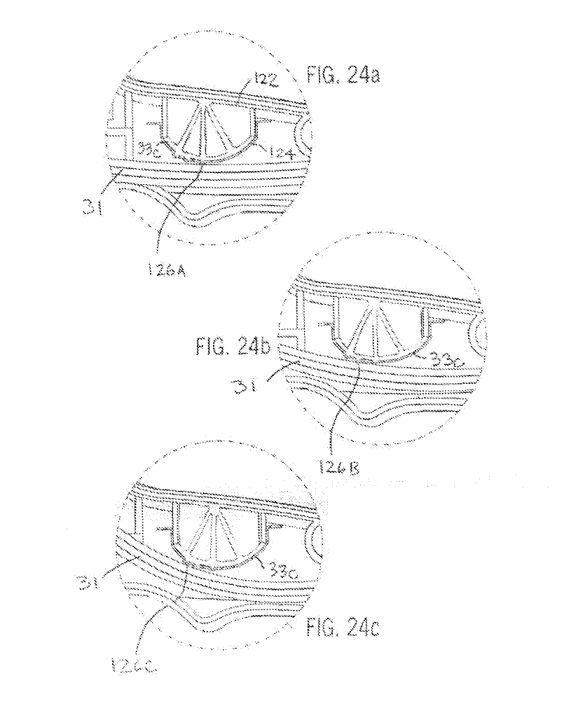

Referring to FIGS. 24a-24c, in another embodiment the stapler 10 includes a fulcrum member 33c which is also configured to take advantage of the variation in hand strength of a person according to the position of an operator's fingers. In particular, fulcrum member 33c includes a plastic frame 122 and a metal covering 124 having a plurality of ridges. As the handle and lever are brought together during a stapling stroke, the leaf springs 31 are bent and the front ends of the leaf springs 31 are increasingly forced upwards. The ridges contact the leaf springs 31 at distinct fulcrums 126A, 126B, and 126C sequentially, which are increasingly closer to the front end or hammer of the staple gun during a stapling stroke. This means that an effective lever arm length of the springs 31 is greater at the beginning of a stapling stroke compared to later in the stapling stroke. A longer effective lever arm at the beginning of a stapling stroke corresponds to a greater mechanical advantage, such that less hand force is required to move the ends of springs 31 a predetermined amount at the beginning of a stapling stroke as compared to later in the stapling stroke.

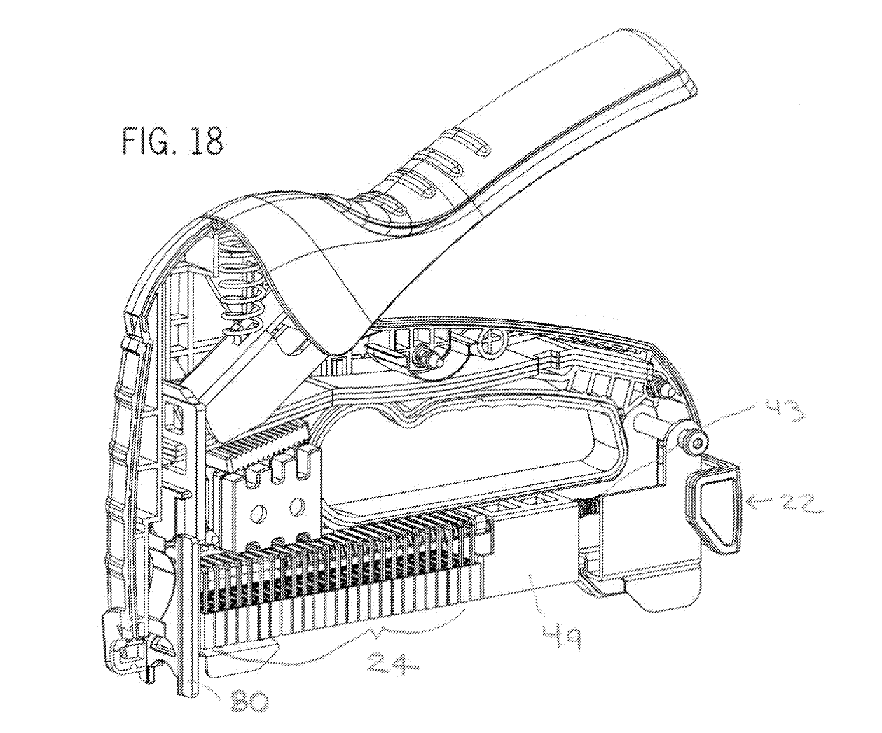

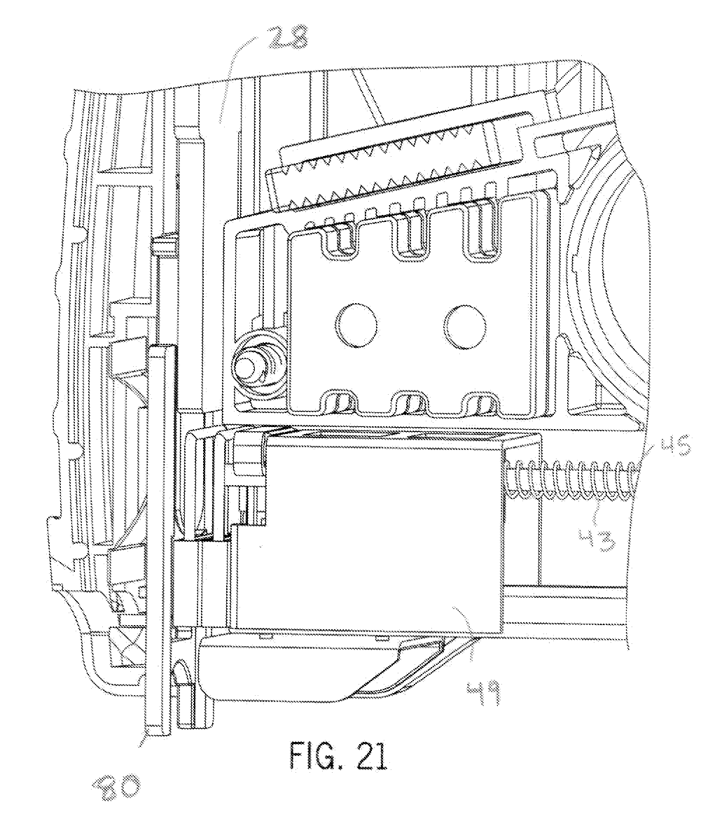

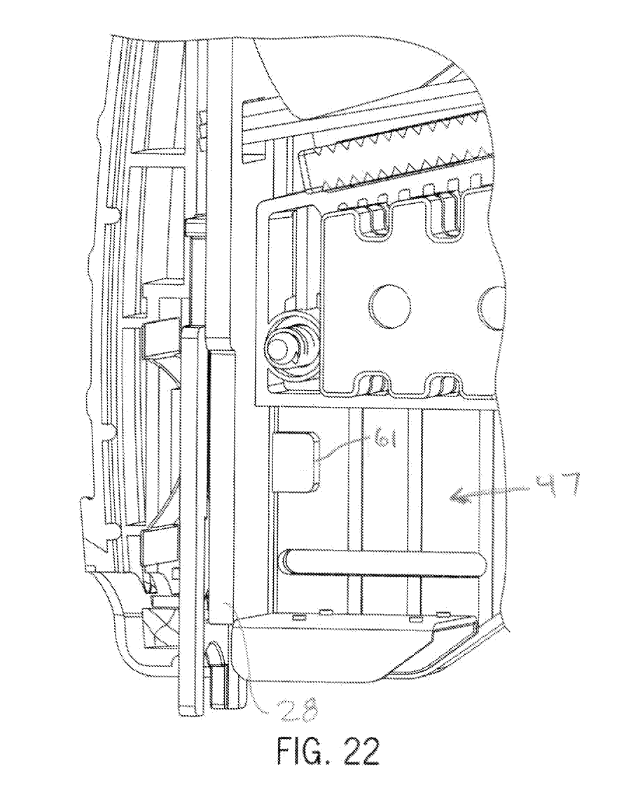

As shown in FIGS. 18-22, the pusher 22 is located within liner 48 of chamber 18 which is mounted in a passageway 47 (see FIG. 22) of the stapler 10. The pusher 22 includes feed head 49 biased by a compression spring 43 mounted on an orientation member or rod 45. The feed head 49 is forwardly biased by the spring 43 such that in the at rest or deactuated position of the lever 14, the row of staples 24 is pushed up against the back of the hammer 28 by the feed head 49, and when the hammer 28 is driven upwards during a stapling stroke, the feed head 49 moves forwardly pushing the staples forwardly in the trackway to push the forward most staple into the channel 39 to be driven by the hammer 28. More particularly, as shown in FIG. 21, when the hammer 28 is lifted sufficiently, so that its bottom end is above the staple, the staples are pushed forwardly a distance represented by the thickness of the hammer such that the forward most staple comes to rest against the back of the cable guide member 80 in the channel 39 and any other staples remain in the trackway.

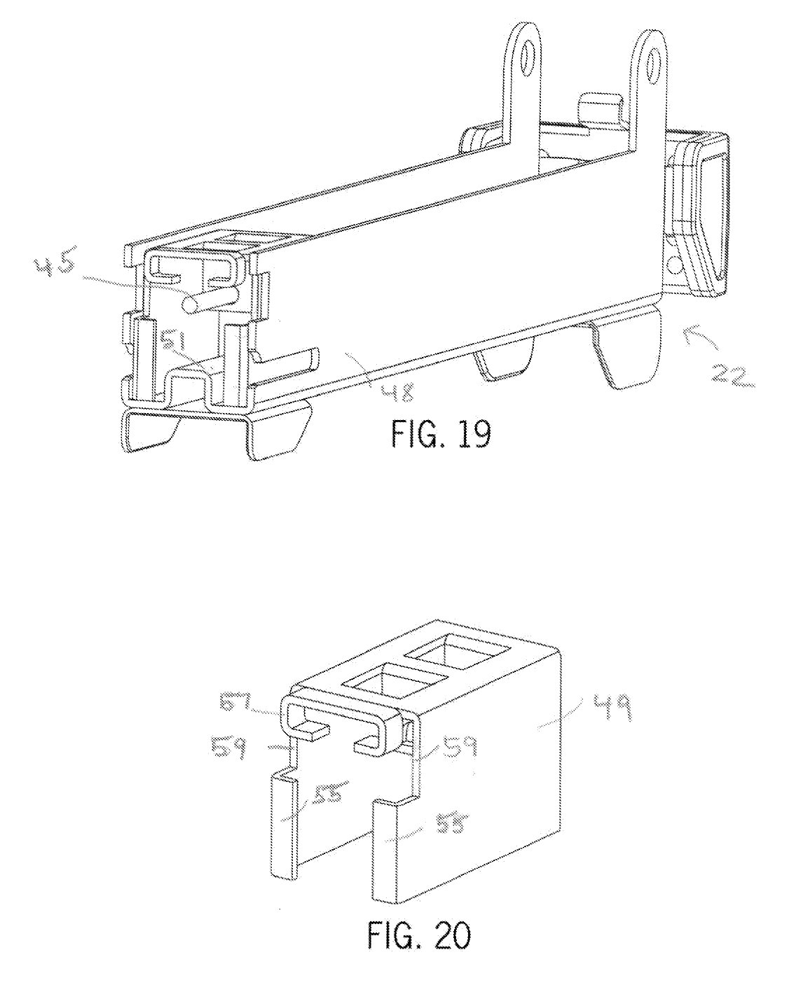

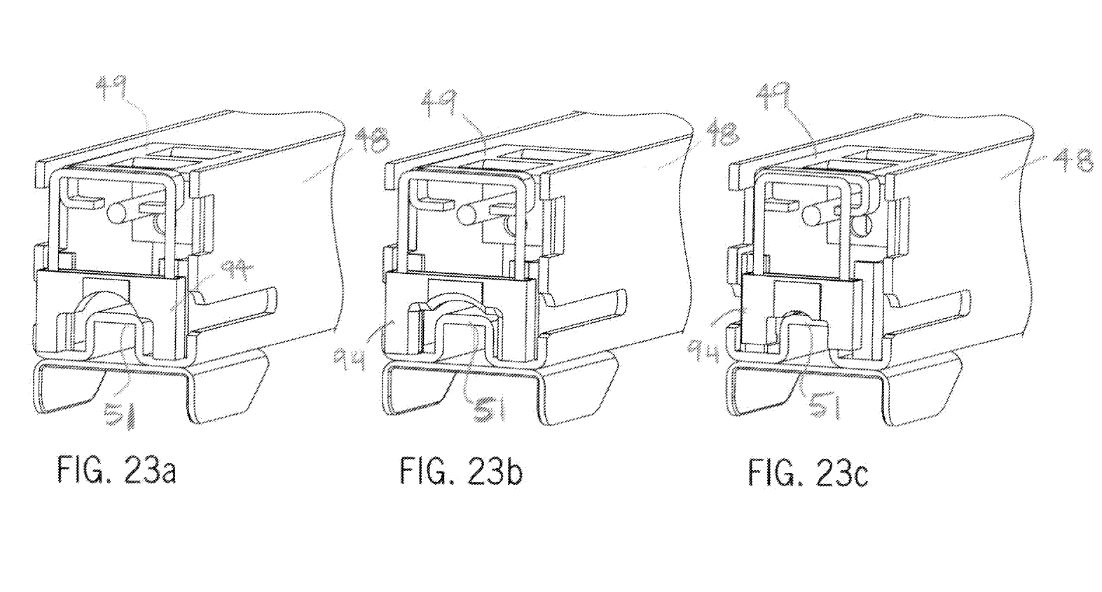

As best seen in FIG. 19, liner 48 includes a center ridge 51 extending lengthwise. The stapler can accommodate different sized staples, as shown in FIGS. 23a-23c, and depending on their size, the staples in the trackway may have an inner surface of the plastic body part 94 resting on the ridge 51, or may have legs of the plastic body part 94 resting on the bottom of liner 48.

FIG. 20 illustrates the details of the feed head 49 which includes lower pushing surfaces 55 for pushing the staples, an upper stabilizing member 57, and surfaces 59. When the last staple is in the channel 39 ready to be driven by the hammer 28, a stop 61 (shown in FIG. 22) formed in the passageway 47 of stapler 10 comes to rest against one of the surfaces 59 and prevents the feed head 49 from moving forwardly into the channel 39 and thereby preventing damage to the pusher head from hammer impact. The stabilizing member 57 keeps the staple in the channel 39 remaining generally upright by preventing it from leaning too far back and helps prevent the stapler 10 from jamming.

FIG. 1 shows two cable guide members 80, although with any one stapler, only one cable guide member would typically be used. Two cable guide members are shown in FIG. 1 to illustrate that the same cable guide member may be installed in the stapler in either of two orientations.

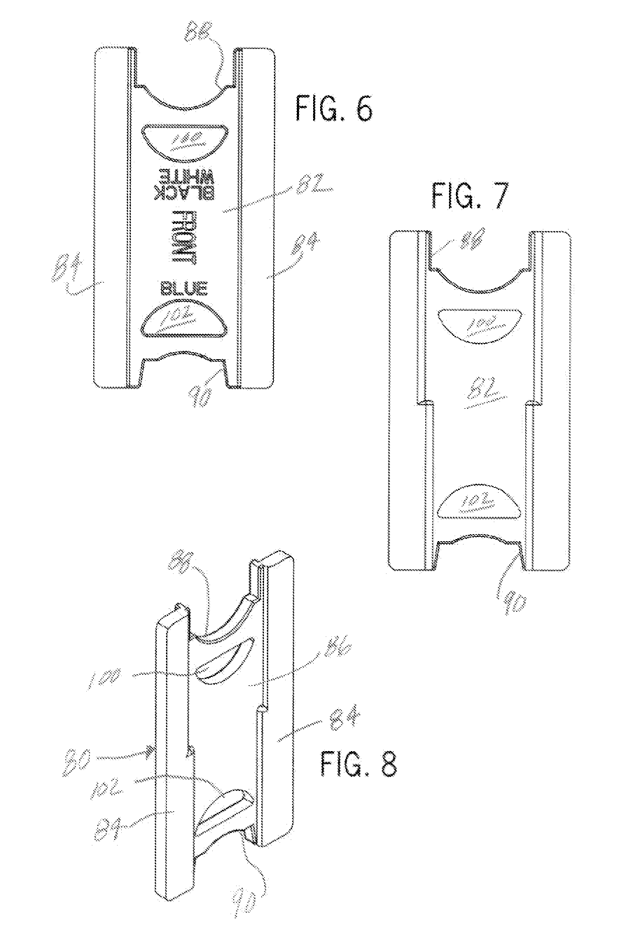

Referring to FIGS. 6-8, the central portion 82 of the cable guide member is offset longitudinally toward the front of the stapler by a small amount from the side portions 84 of the cable guide member. Further, it can be seen that on the rear side 86 of the cable guide member 80, the offset central portion 82 is wider at one end of the cable guide member 80 than it is at the other end. Each end of the cable guide member 80 has a cable guideway formed in it, which is a recess that is sized for particularly sized cables. The cable guideways 88 and 90 are formed with central arced portions that are provided to accommodate round wires, but extend outwardly from the central arc portion to accommodate wider flat wires as well. The guideway 88 can accommodate larger wires, either flat or round, than the guideway 90, as the guideway 88 is both wider and taller than the guideway 90. It is also to be noted that when the cable guide member 80 is assembled with the guideway 88 up, the front of the stapler is held up off of the substrate by a smaller distance than when the cable guide member 80 is assembled to the stapler 10 with the guideway 90 at the top.

It is noted that the hammer 28 slides up and down in the head 26 and is guided in its up and down movement in the channel 39 by tracks 99 (FIG. 11) at its sides which are formed in each of the two halves 13A and 13B of the body 12. Tracks 99 are a little wider at the top than they are at the bottom so that the hammer 28 can be pushed away from engagement with the nose 68 as shown in FIGS. 15 and 16 when it is at the top of its motion.

Tab 92 at the top of the hammer 28 is bent forwardly and the bottom of the nose 68 is rounded so as to cam on the bent tab 92 of the hammer 28 when the lever 14 is pressed down by the compression spring 40 so as to re-engage the nose 68 in preparation for the next upstroke of the hammer 28.

As described above, when the lever 14 is actuated or cocked, it lifts the hammer 28 from being in front of the row of staples and when the hammer 28 is lifted high enough to clear the staples, the feed head 49 pushes the staples 24 forwardly to contact the backside of the side portions 84 of the cable guide member 80 with the front staple. The guideway 88 or 90 corresponds in size or shape to the guideway shape of the staple. The plastic body part 94 of the front staple contacts the side portions 84 of the guide member 80. At the end of guide member having the smaller guideway 90, the side portions 84 are wider, and at the end of the guide member having the larger guideway 88, the side portions 84 are more narrow. The D-shaped openings 100 and 102 formed in the guide member 80 are to provide a finger gripper hole so that a user can grab hold of the cable guide member 80 to remove it from the stapler body 12 in order to change its orientation. The cable guide member 80 also has “FRONT” indicia on its front surface to indicate the correct orientation, and has “BLUE” at the end corresponding to guideway 90 and “BLACK WHITE” at the end corresponding to guideway 88 to indicate the colors of staples, and therefore the sizes, of the staples that should be driven at those ends.

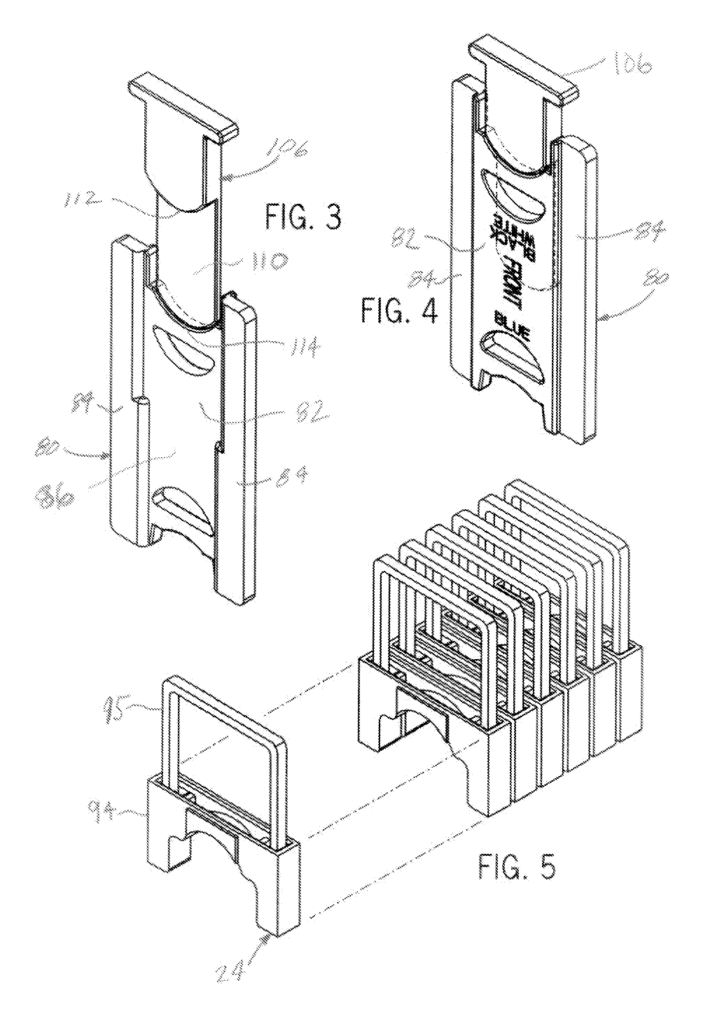

Referring to FIGS. 2, 3 and 4, a leaf spring 104 having enlarged ends is held in the head 26, with its enlarged ends being received in suitable recesses in the head 26 so as to hold the spring 104 therein. The spring 104 bears against the front surface of the cable guide member 80 to provide friction to hold the cable guide member 80 in the head 26. The cable guide member 80 is received in guideways formed by the two halves 13A and 13B of the body 12 and the cable guide stop 106 is received in the body 12 and fixed therein so that when the cable guide member 80 is slid into the body 12, the tongue portion 110 of the guide stop 106 overlaps the central part 82 of the guide member 80 on the rear side and the nose 112 of the guide stop abuts the guideway 88 or 90 in the curved central arc portion of the guideway. If it is tried to insert the cable guide member 80 in the wrong orientation, with its front surface facing rearwardly as shown in FIG. 3, the lower nose 114 of the stop 106 will contact the curved central portion of the guideway 88 or 90 to prevent further insertion of the guide member 80 in that orientation. The stop 106 is trapped in the housing by the housing having recesses in which the upper shoulders of the stop 106 fit. Spring 104 presses the member 80 against the tongue portion 110 of the stop 106 to hold it inside of the stapler 10 during normal use.

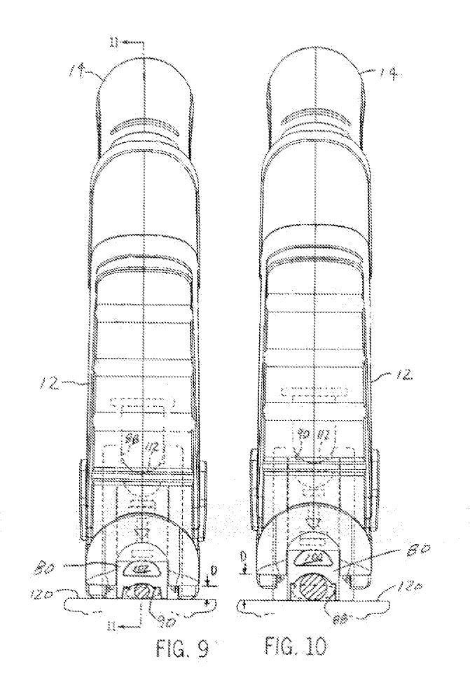

Referring to FIGS. 9 and 10, when the guide member 80 is assembled to the stapler with the smaller guideway 90 at the bottom, as shown in FIG. 9, only a relatively smaller round or flat or oblong cable may be stapled. In that orientation of the guide member 80, the stapler body 12 is held a certain distance D off of the substrate 120. Referring to FIG. 10, when the guide member 80 is flipped over with the guideway 88 at the bottom, for stapling larger cables, the stapler body 12 is held further off of the substrate 120 so that the distance D in FIG. 10 is greater than the distance D in FIG. 9. Thus, not only is the guideway 88 larger than the guideway 90, but the stapler 10 is also supported higher off of the substrate surface to be stapled in this orientation.

The reason that the orientation shown in FIG. 10 holds the stapler further off the substrate than the orientation in FIG. 9 is that the nose 112 of the stop 106 can extend further into the guideway 88 than it can into the guideway 90, also as illustrated in FIGS. 9 and 10. Since it can't extend into the guideway as far in the orientation in FIG. 10, the cable guide member 80 extends further from the bottom of the stapler body 12.

The stapler 10 needs to have a groove defined at its bottom for its length, and for this purpose, the feet 130 are provided at the rear end of the stapler 10 and between them define the groove through which the cable being stapled can run.

Various embodiments of a stapler of the invention have been described in considerable detail. Many modifications and variations to the embodiments described will be apparent to those skilled in the art. Therefore, the invention should not be limited to the embodiments described, but should be defined by the claims below.

1. In a staple gun of the type that has a body that includes a staple chamber that holds staples in a row to be fed below a hammer contained in the body and an actuator that operates the hammer to drive a staple presented in the chamber below the hammer, the improvement wherein the body contains weights that serve only to increase the weight and inertia of the stapler.

2. A stapler as in claim 1, wherein the weights are positioned in the body horizontally near the hammer.

3. A stapler as in claim 1, wherein the weights are positioned in elevation below a handle of the body.

4. In a staple gun of the type that has a body that includes a staple chamber that holds staples in a row to be fed below a hammer contained in the body and an actuator that operates the hammer to drive a staple presented in the chamber below the hammer, the improvement wherein the staple gun is capable of driving at least two differently sized staples wherein one cable guideway is used in the staple gun for one of the staple sizes and a different cable guideway is used in the staple gun for the other staple size, wherein one of the guideways is provided at one end of a cable guide member and the other guideway is provided at an opposite end of the same cable guide member.

5. In a staple gun as claimed in claim 4, wherein the staples are of different widths.

6. In a staple gun as claimed in claim 4, wherein the staples are of different heights.

7. In a staple gun as claimed in claim 4, wherein staples in the chamber stop against a rear surface of the cable guide member.

8. In a staple gun as claimed in claim 4, wherein the cable guide member can only be inserted into the stapler with a rearward surface of the member facing rearwardly.

9. In a staple gun as claimed in claim 4, wherein the cable guide member has indicia to indicate which surface is its rearward surface.

10. In a staple gun as claimed in claim 4, wherein the cable guide member has indicia to indicate which guideway to use for different staples.

11. In a staple gun as claimed in claim 4, wherein the cable guide member has grippers to facilitate removal by a user from the staple gun.

12. In a staple gun as claimed in claim 4, wherein in one orientation the cable guide member supports a front of the chamber further from the support surface than in the other orientation of the cable guide member.

13. In a staple gun of the type that includes a handle, a pivotable lever, a hammer, a fulcrum member, a staple chamber that holds staples in a row to be fed below the hammer to drive a staple presented below the hammer, leaf springs extending from one end of the staple gun to near the hammer, wherein the fulcrum member contacts the leaf springs at an area of contact that defines a fulcrum for the leaf springs, the improvement wherein the fulcrum member is configured such that the fulcrum moves toward the hammer along a path as the lever and handle are moved towards each other at a rate faster than if the fulcrum path was defined by a fixed radius fulcrum member.

14. In a staple gun of the type that includes a handle, a pivotable lever, a hammer, a fulcrum member, a staple chamber that holds staples in a row to be fed below the hammer to drive a staple presented below the hammer, leaf springs extending from one end of the staple gun to near the hammer, wherein the fulcrum member contacts the leaf springs at an area of contact that defines a fulcrum for the leaf springs, the improvement wherein the fulcrum member includes a plurality of ridges such that as the lever and the handle are moved toward each other, each ridge sequentially contacts the leaf springs at a corresponding distinct fulcrum which is closer to the hammer than a previous fulcrum.

15. The staple gun of claim 14, wherein the sequential fulcrums define a path that is not defined by a fixed radius.

16. The staple gun of claim 14, wherein the ridges get correspondingly bigger in a direction towards the hammer.

17. In a staple gun of the type that includes a spring-biased feed head for advancing staples forwardly from a chamber into a channel to be individually driven by a hammer, the improvement wherein the feed head includes a lower pushing surface contacting a body portion of the last staple in the chamber to move the staples forwardly and an upper surface for limiting the amount of tilt of the staple in the channel to prevent the stapler from jamming.

18. The staple gun of claim 17, wherein the staple gun includes a passage for holding the feed head, and the passage has a stop for engaging with a surface of the feed head to prevent the feed head from advancing into the channel.

19. The stapler as in claim 1, wherein the weights comprise free weights.

20. The stapler as in claim 19, wherein the free weights are snap-fit together.

21. The stapler as in claim 1, wherein the weights are interference fit into a recess of the body so that the weights do not rattle around in the body.
